(19) United States
(12) Patent Application Publication
(10) Pub. No.: US 2011/0075346 A1
(43) Pub. Date: Mar. 31, 2011

(54) Information Processing Apparatus

(76) Inventor: Isao Okutsu, Hamura-shi (JP)

(21) Appl. No.: 12/878,296

(22) Filed: Sep. 9, 2010

(30) Foreign Application Priority Data
Sep. 30, 2009 (JP) 2009-228899

(51) Int. Cl. G06F 1/16

(52) U.S. Cl. 361/679.31

(57) ABSTRACT

An information processing apparatus includes: a housing; a main circuit board housed inside the housing and having a notch portion; and a storage device disposed inside the housing and having at least a part of a body of the storage device being disposed within the notch portion, the storage device having an installation surface being set to have a predetermined angle with respect to a board surface of the main circuit board.

### CROSS REFERENCE TO RELATED APPLICATION(S)

The application is based upon and claims the benefit of priority from Japanese Patent Application No. 2009-228899 filed on Sep. 30, 2009, the entire contents of which are incorporated herein by reference.

### BACKGROUND

1. Field

The present invention relates to an information processing apparatus having a built-in storage device such as an HDD (Hard Disk Drive) or an SSD (Solid State Drive).

2. Description of the Related Art

Various notebook type PCs (Personal Computers) that are easily portable and high in performance have been provided in recent years. This type of computer has a housing having a box shape, and a flat-screen display unit attached to a rear portion of the housing so that the display unit can be opened and closed. A storage device such as an HDD (Hard Disk Drive), an SDD (Solid State Drive) or a floppy (registered trademark) disk drive is housed inside the housing.

As for an improvement of a slot for inserting a medium such as a floppy (registered trademark) disk into an electronic information apparatus, there has been proposed an electronic information apparatus having an insertion slot for mounting/unmounting a medium into/from an external storage device in its side surface, wherein the insertion slot is formed so that a length direction of the insertion slot descends frontward obliquely with respect to a front-rear direction of the electronic information apparatus, as disclosed in JP-A-9-052715.

A notebook type PC has a main circuit board and a storage device such as an HDD or an SDD which are provided inside a housing. The main circuit board is generally provided as a rectangular flat board having a board thickness not larger than 2 mm. When, for example, a 2.5 inch-size HDD is used, the HDD is substantially shaped like a shaped in a box-shape 69.85 mm wide, 100 mm deep and 9.5 mm thick and has a rear portion in which a power supply and a signal connector are disposed. The main circuit board and the storage device such as an HDD or an SSD are connected to each other by connectors directly or by connectors through a flexible cable.

A board surface of the main circuit board and an installation surface of the storage device (a surface defined based on a width direction and a depth direction of the storage device) are heretofore disposed in parallel with each other. If a module etc. for performing communication etc. is disposed on a top surface of the storage device, the thickness of a resulting product increased. If the product thickness is intended to be reduced, it is impossible to dispose the module etc. for performing communication etc. on the top surface of the storage device. As a result, the size of the resulting product increased.

As for the latest notebook type PC, reduction in thickness of a housing of the PC has been promoted to make it easy to handle the PC at carrying the PC. The storage device might be disposed on a front surface side of the PC. If the board surface of the main circuit board and the installation surface of the storage device are parallel with each other, there is a barrier to reduction in thickness of the PC.

Moreover, because there is a problem that increasing in thickness of the housing disfigures the electronic apparatus, ingenuity to make the outer shape look thin is required from this point of view. In addition, formation of the periphery of the outer shape of the PC as a thin shape is required so that it could be easy to take the PC in and out when the PC is put in a casing or bag.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a perspective view showing an external appearance of an information processing apparatus according to the invention;

FIG. 2 is a view showing an example of a shape of a main circuit board;

FIG. 3 is a view showing a positional relation and connection state between the main circuit board and a storage device;

FIG. 4 is a schematic sectional view showing a side surface of the information processing apparatus;

FIG. 5 is a view showing a method of fixing the storage device; and

FIG. 6 is a view showing another example of the positional relation between the main circuit board and the storage device.

### DETAILED DESCRIPTION OF THE EMBODIMENTS

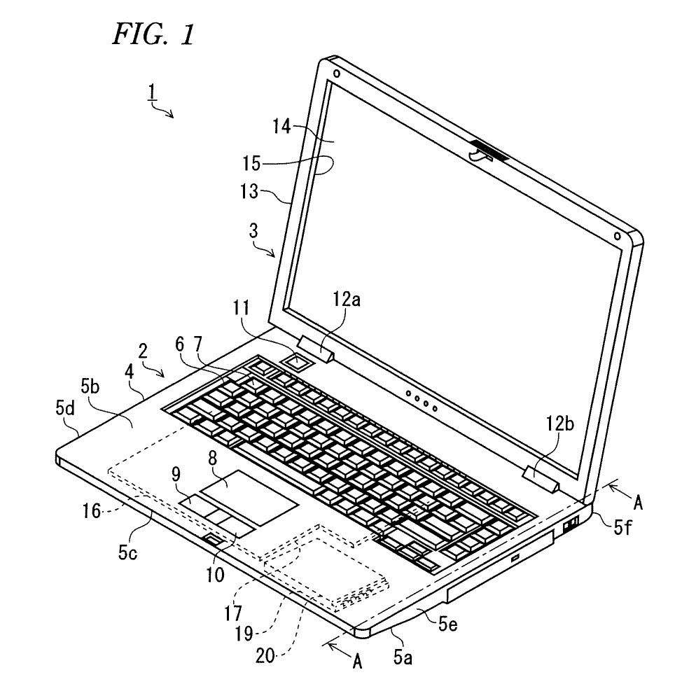

An embodiment of the invention will be described below with reference to the drawings. FIG. 1 is a perspective view showing the external appearance of an information processing apparatus 1 according to the invention. The information processing apparatus 1 includes a base unit 2 substantially shaped like a flat rectangular box, and a flat-screen display unit 3. The base unit 2 has a housing 4 which forms a contour of the base unit 2. The housing 4 has bottom and top surfaces 5a and 5b opposite to each other, and front, left, right and rear surfaces 5c, 5d, 5e and 5f continuing to the bottom and top surfaces 5a and 5b.

A keyboard device 6 as an information input unit, a touch pad 8 for moving a pointer on a display, left and right buttons 9 and 10 for issuing operation instructions and a power switch 11 are disposed on the top surface 5b of the housing 4. The keyboard device 6 has a large number of keys 7 which are arranged substantially on the same plane with the top surface 5b of the housing 4. Protrusions 12a and 12b for supporting the display unit 3 are provided in a rear end portion of the top surface 5b of the housing 4.

The display unit 3 has a housing 13 shaped like a thin box, and a liquid crystal display 14 housed in the inside of the housing 13. The liquid crystal display 14 is exposed to the outside through a display opening portion 15 formed on the housing 13. The housing 13 is connected to the protrusions 12a and 12b of the top surface 5b of the housing 4 through hinge devices that are not shown, respectively. Accordingly, the display unit 3 can rotate between a closed position where the top surface 5b of the housing 4 is hidden under the display unit 3 and an opened position where the liquid crystal display 14 is raised at a rear part of the top surface 5b of the housing 4.

A main circuit board 16 is fixed inside the housing 4 so as to be substantially parallel with the top surface 5b of the housing 4. The main circuit board 16 is a circuit board in which an integrated circuit for a CPU (Central Processing Unit) or the like and a large number of electronic components such as resistors, capacitors, etc. are surface-mounted on a printed wiring board having a board thickness not larger than 2 mm. The main circuit board 16 has a notch portion 17 as a part thereof.

A storage device 19 is disposed in a region of the notch portion 17 of the main circuit board 16. The storage device 19 is substantially shaped like a box. For example, the storage device 19 is configured as an HDD or an SSD. At least one part of a body 20 of the storage device 19 is disposed in the region of the notch portion 17. The storage device 19 is provided so that an installation surface of the body 20 is inclined at a predetermined angle with respect to the board surface of the main circuit board 16. The predetermined angle is in a range of from 1 degree to 30 degrees. With respect to a direction of the inclination, the installation surface of the body 20 is inclined in such a direction that a side surface of the body 20 near the front surface 5c of the housing 4 comes close to the top surface 5b of the housing 4.

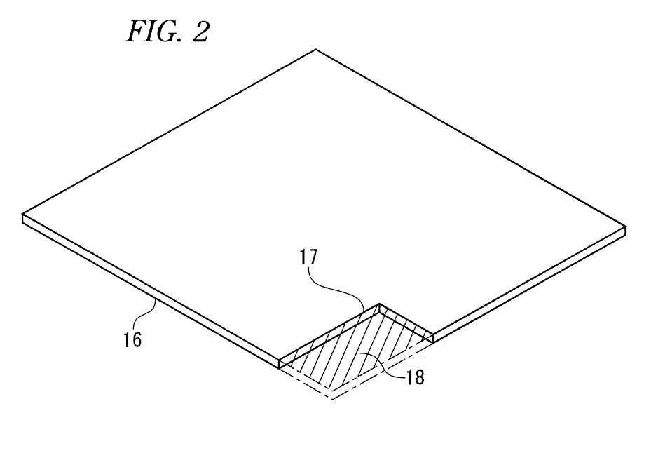

FIG. 2 is a view showing an example of the shape of the main circuit board 16. Although FIG. 2 shows the case where the main circuit board 16 is substantially shaped like a rectangle, the shape of the main circuit board 16 is not limited thereto. The main circuit board 16 has a notch portion 17 as a part thereof. A region 18 of the notch portion 17 is hatched in FIG. 2. Although FIG. 2 shows the case where the region 18 of the notch portion 17 is shaped like a rectangle, the shape of the region 18 is not limited thereto. Because the storage device 19 is disposed in a position near the front surface 5c of the housing 4 as shown in FIG. 1, the region 18 of the notch portion 17 is also disposed in a position near the front surface 5c of the housing 4.

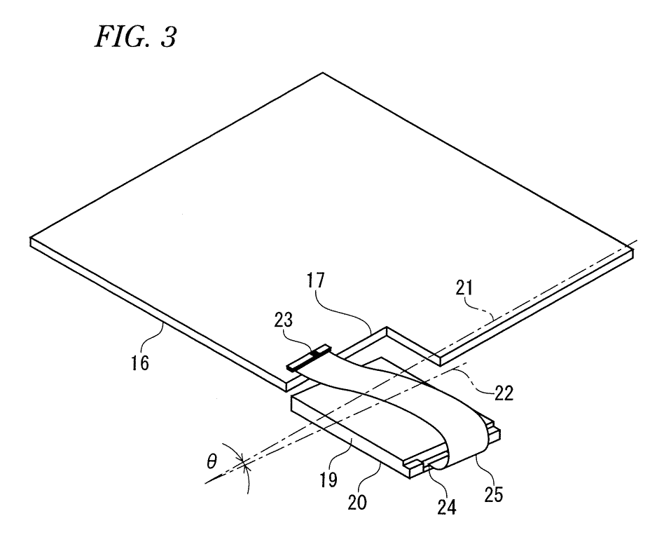

FIG. 3 is a view showing the positional relation and connection state between the main circuit board 16 and the storage device 19. At least one part of the body 20 of the storage device 19 is disposed in the region 18 of the notch portion 17. The storage device 19 is provided so that the installation surface of the body 20 is inclined at a predetermined inclination angle with respect to the board surface of the main circuit board 16. A connector 23 of the main circuit board 16 and a connector 24 of the storage device 19 are connected to each other by FPCs (Flexible Printed Circuits) or by a flexible cable 25 such as an FTC (Flexible Flat Cable).

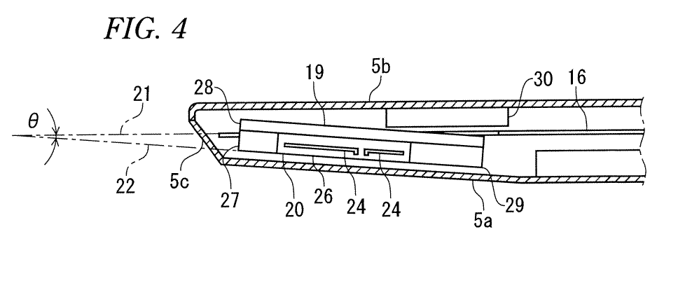

FIG. 4 is a schematic sectional view showing a side surface of the information processing apparatus 1. The sectional view is taken along the line A-A in FIG. 1. An additional line 21 is a line which indicates the inclination of the board surface of the main circuit board 16 and which is substantially parallel with the top surface 5b of the housing 4. An additional line 22 is a line which indicates the inclination of the installation surface 26 of the body 20 of the storage device 19. The additional line 21 is at a predetermined angle θ with respect to the additional line 22. Accordingly, the body 20 of the storage device 19 is inclined at a predetermined angle θ with respect to the board surface of the main circuit board 16. The size of the inclination angle θ is in a range of from 1 degree to 30 degrees. The body 20 of the storage device 19 is inclined in such a direction that a side surface 27 of the body 20 near the front surface 5c of the housing 4 comes close to the top surface 5b of the housing 4. As shown in FIG. 4, the storage device 19 is disposed in a position near the front surface 5c of the housing 4. Incidentally, the cable 25 is not shown in FIG. 4.

The main circuit board 16 is disposed between a region 28 where the body 20 of the storage device 19 is nearest to the top surface 5b of the housing 4 and a region 29 where the body 20 of the storage device 19 is farthest from the top surface 5b of the housing 4. Because the body 20 of the storage device 19 is substantially shaped like a box, the nearest region 28 in FIG. 4 is equivalent to a ridgeline of the side surface 27 near the top surface 5b of the housing 4.

The bottom surface 5a of the housing 4 is formed so that at least one part of the bottom surface 5a of the housing 4 opposite to the body 20 of the storage device 19 is substantially parallel with the installation surface 26 of the body 20 of the storage device 19. The bottom surface 5a of the housing 4 is formed so that a region of the bottom surface 5a of the housing 4 near the front surface 5c of the housing 4 is substantially parallel with the installation surface 26 of the body 20 of the storage device 19. Alternatively, the portion or region may be not substantially parallel with the installation surface 26 of the body 20 of the storage device 19 but set at an angle different from the inclination angle of the installation surface 26 of the body 20 of the storage device 19. For example, the portion or region may be set at an angle different by a value of from 1 degree to 5 degrees. In this manner, the height of the front surface 5c of the housing 4 of the information processing apparatus 1 can be lowered, so that the leading end portion of the housing 4 can be made thin. While the aesthetic aspect of the housing 4 can be improved because the leading end portion of the housing 4 looks thin when viewed from the front surface 5c, the information processing apparatus 1 can be taken in and out easily when the information processing apparatus 1 is put in a PC casing or bag. In addition, the total size of the information processing apparatus 1 can be reduced.

Because the storage device 19 is disposed so as to be inclined with respect to the board surface of the main circuit board 16, a wedge-like space is formed between the body 20 of the storage device 19 and the top surface 5b of the housing 4 so that the wedge-like space is formed as a large space particularly in a region far from the front surface 5c. This space can be used so that a module 30 for performing communication etc. can be disposed in this space. For example, the module 30 for performing communication etc. is a communication module such as Felica (registered trademark), TransferJet (registered trademark), Bluetooth (registered trademark), etc.

Because the module 30 for performing communication etc. can be disposed just under an inner wall of the top surface 5b of the housing 4, it is possible to improve the function and performance of communication with the outside through the top surface 5b of the housing 4. The bad influence of the main circuit board 16 on communication interception or communication interference can be avoided, so that good communication performance can be ensured. Incidentally, the module 30 for performing communication etc. may be replaced by a small board etc. in which a storage media slot for bridge media, a mini-SD card slot or the like is mounted.

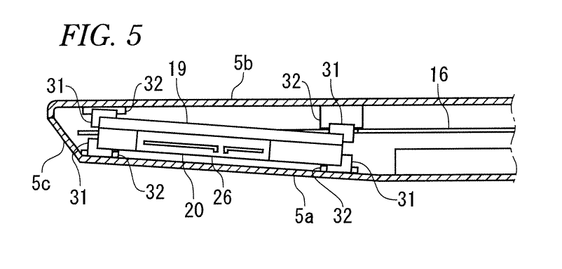

FIG. 5 is a view showing a method of fixing the storage device 19. The body 20 of the storage device 19 is substantially shaped like a box. Elastic support members 31 are disposed on four corners of the installation surface 26 and four corners of a surface opposite to the installation surface 26. The elastic support members 31 are supported by support member fixing portions 32 which are disposed on the inner wall side of the top surface 5b of the housing 4 and the inner wall side of the bottom surface 5a thereof. Accordingly, the storage device 19 is supported so elastically that external impulsive force applied on the housing 4 can be prevented from being transmitted to the storage device 19.

As described above, the bottom surface 5a of the housing 4 is formed so that a region of the bottom surface 5a of the housing 4 near the front surface 5c of the housing 4 is substantially parallel with the installation surface 26 of the body 20 of the storage device 19 or not substantially parallel but inclined at an angle slightly different from the inclination angle of the installation surface 26 of the body 20 of the storage device 19. Accordingly, the height of the front surface 5c of the housing 4 of the information processing apparatus 1 can be lowered so that the leading end portion of the housing 4 can be made thin.

Moreover, because the storage device 19 is disposed so as to be inclined with respect to the board surface of the main circuit board 16, a wedge-like space can be formed between the body 20 of the storage device 19 and the top surface 5b of the housing 4 so that the module 30 for performing communication etc. can be disposed between the inner wall of the top surface 5b of the housing 4 and the storage device 19. Accordingly, both reduction in footprints of the main circuit board 16 and reduction in thickness of the housing 4 can be achieved.

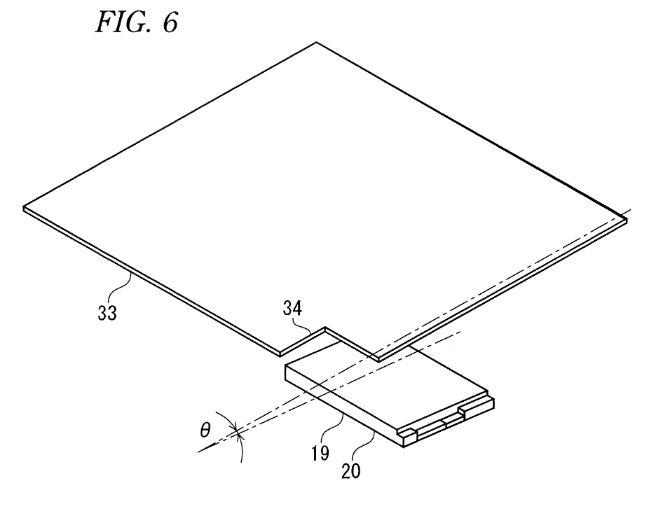

FIG. 6 is a view showing another example of the positional relation between a main circuit board 33 and the storage device 19. At least one part of the body 20 of the storage device 19 is disposed in a region of a notch portion 34. The storage device 19 is inclined so that the installation surface of the body 20 is at a predetermined angle with respect to the board surface of the main circuit board 33. The point of difference from the arrangement shown in FIG. 3 is that the main circuit board 33 is disposed so as to partially overlap with the storage device 19. Even in this arrangement, the height of the front surface 5c of the housing 4 of the information processing apparatus 1 can be lowered so that the leading end portion of the housing 4 can be made thin.

Incidentally, the invention is not limited to the aforementioned embodiment directly and constituent members can be modified to embody the invention without departing from the gist of the invention in a practical stage. Constituent members disclosed in the aforementioned embodiment may be combined suitably to form various inventions. For example, some constituent members may be removed from all constituent members disclosed in one embodiment. In addition, constituent members disclosed in different embodiments may be combined suitably.

What is claimed is:

1. An information processing apparatus comprising:
a housing;
a main circuit board housed inside the housing and comprising a notch portion; and
a storage device disposed inside the housing and comprising at least apart of a body of the storage device being disposed within the notch portion, the storage device comprising an installation surface being set to have a predetermined angle with respect to a board surface of the main circuit board.

2. An information processing apparatus comprising:
a housing comprising bottom and top surfaces opposite to each other, the housing further comprising a front surface continuing to the bottom and top surfaces;
a main circuit board disposed inside the housing so as to be substantially parallel with the top surface and comprising a notch portion; and
a storage device disposed inside the housing and comprising at least a part of a body of the storage device being disposed within the notch portion, wherein the storage device is housed in the inside of the housing so that an installation surface of the body is at a predetermined angle with respect to a board surface of the main circuit board, and that the body is inclined toward a direction that a side surface of the body disposed near the front surface of the housing comes close to the top surface of the housing.

3. The apparatus of claim 2, wherein
the main circuit board is disposed at a position between a first region of the body of the storage device nearest to the top surface of the housing and a second region of the body of the storage device farthest from the top surface of the housing.

4. The apparatus of claim 2, wherein
at least a part of the bottom surface of the housing opposite to the body of the storage device is substantially in parallel with the installation surface of the body of the storage device.

5. The apparatus of claim 2, wherein
a region of the bottom surface of the housing near the front surface of the housing is substantially in parallel with the installation surface of the body of the storage device.
